(19) United States
(12) Patent Application Publication
(10) Pub. No.: US 2004/0263857 A1
(43) Pub. Date: Dec. 30, 2004

(54) Fiber-optic gauge having one or more side-mounted sensors

(76) Inventors: Nagesh R. Basavanhally, Skillman, NJ (US); Hong Tang, Belle Mead, NJ (US)

Correspondence Address: STEVE MENDELSOHN, MENDELSOHN & ASSOCIATES, P.C., 1515 MARKET STREET, SUITE 715, PHILADELPHIA, PA, 19102, US

(21) Appl. No.: 10/602,476

(22) Filed: Jun. 24, 2003

(51) Int. Cl. G01B 9/02

(52) U.S. Cl. 356/480

(57) ABSTRACT

A fiber-optic gauge having at least one sensor mounted onto a side of an optical fiber. In one embodiment, the sensor is optically coupled to the fiber using a thin-film filter inserted into the fiber and preferably oriented at about 45 degrees with respect to the fiber axis. The sensor may be one of a plurality of sensors similarly mounted on and optically coupled to a single optical fiber. Each sensor is designed to change its reflectivity in response to a change in an external physical parameter, e.g., pressure, and is preferably adapted for interrogation with monochromatic light. The interrogating light has a plurality of wavelength components, each corresponding to a different sensor. Light reflected from the sensors is de-multiplexed and analyzed to measure the reflectivity of each sensor and to derive the corresponding value of the physical parameter, thereby providing a parameter measurement at each sensor location. Advantageously, gauges of the invention may be used in medical applications such as arterial catheterization to provide, e.g., real-time blood-pressure sampling around a damaged area of an artery, while decreasing the patient's trauma compared to that inflicted by prior-art devices where multiple optical fibers are used for a similar measurement.

### BACKGROUND OF THE INVENTION

1. Field of the Invention

The present invention relates to the field of instrumentation and, more specifically, to sensing devices, such as fiber-optic gauges.

2. Description of the Related Art

Miniature fiber-optic gauges may be used in a variety of applications. For example, a gauge having a pressure sensor may be inserted into a patient's artery to monitor blood pressure during a medical procedure such as an angioplasty.

A representative prior art fiber-optic gauge available from FISO Technologies, Inc., of Quebec, Canada is based on a Fabry-Perot interferometer (FPI). The gauge has a sensor formed by two mirrors that define the interferometer cavity. The cavity is coupled to an optical fiber and acts as a wavelength modulator whose reflection (transmission) characteristics depend on the cavity length. For example, a beam of light having a flat (i.e., wavelength-independent or “white”) spectrum is reflected back from the cavity as a beam of light whose spectrum is a periodic function of wavelength. By appropriately analyzing the reflected light, e.g., as described in U.S. Pat. Nos. 5,202,939 and 5,392,117, the teachings of both of which are incorporated herein by reference, the cavity length can be measured. The obtained length value may then be related to an external physical parameter, such as strain, stress, pressure, or temperature, affecting the cavity length.

One problem with prior-art fiber-optic gauges is that each sensor is mounted at a terminus of a dedicated optical fiber. As a result, when measurements need to be performed simultaneously at more than one location, a fiber-optic gauge having multiple optical fibers has to be used, where each fiber is dedicated to a corresponding sensor. Such a gauge may be relatively complex and difficult to handle. In addition, in certain applications, the use of gauges having multiple fibers may not be possible at all. For example, the use of such gauges during certain medical procedures would increase the patient's trauma and/or risk of complications and therefore should preferably be avoided.

### SUMMARY OF THE INVENTION

Problems in the prior art are addressed, in accordance with the principles of the invention, by a fiber-optic gauge having at least one sensor mounted onto a side of an optical fiber. In one embodiment, the sensor is optically coupled to the fiber using a thin-film filter inserted into the fiber and preferably oriented at about 45 degrees with respect to the fiber axis. The sensor may be one of a plurality of sensors similarly mounted on and optically coupled to a single optical fiber. Each sensor is designed to change its reflectivity in response to a change in an external physical paraneter, e.g., pressure, and is preferably adapted for interrogation with monochromatic light. The interrogating light has a plurality of wavelength components, each corresponding to a different sensor. Light reflected from the sensors is de-multiplexed and analyzed to measure the reflectivity of each sensor and to derive the corresponding value of the physical parameter, thereby providing a parameter measurement at each sensor location. Advantageously, gauges of the invention may be used in medical applications such as arterial catheterization to provide, e.g., real-time blood-pressure sampling around a damaged area of an artery, while decreasing the patient's trauma compared to that inflicted by prior-art devices where multiple optical fibers are used for a similar measurement.

### BRIEF DESCRIPTION OF THE DRAWINGS

FIG. 1 shows a cross-sectional view of a fiber-optic gauge according to one embodiment of the present invention;

FIG. 2 shows a cross-sectional view of a terminus-mounted pressure sensor that can be used in the gauge of FIG. 1 according to one embodiment of the present invention;

FIG. 3 shows a perspective three-dimensional view of a side-mounted pressure sensor that can be used in the gauge of FIG. 1 according to one embodiment of the present invention;

FIG. 4 shows a block diagram of a gauge interrogation device according to one embodiment of the present invention, where the device is configured to interrogate the fiber-optic gauge of FIG. 1; and

FIG. 5 shows a partial cut-away perspective view of a portion of a medical device according to one embodiment of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

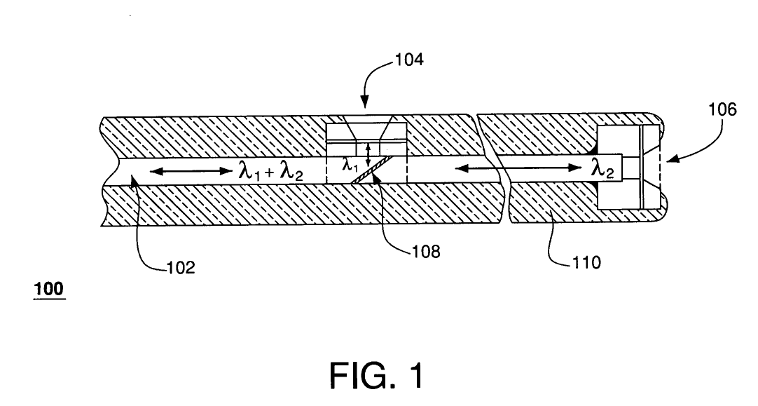

FIG. 1 shows a cross-sectional view of a fiber-optic gauge 100 according to one embodiment of the present invention. Gauge 100 has two sensors 104 and 106 that are coupled to an optical fiber 102 and mounted on a side and at the terminus, respectively, of the fiber. Fiber 102 has a thin-film filter 108 inserted into the fiber and preferably oriented at 45 degrees with respect to the axis of the fiber. Filter 108 is designed to reflect light corresponding to sensor 104 and to transmit light corresponding to sensor 106. Gauge 100 also has an optional jacket 110 placed around fiber 102 and sensors 104 and 106.

In one embodiment, to insert filter 108 into fiber 102, the fiber is sliced at 45 degrees with respect to its longitudinal axis to expose the fiber core. The filter is deposited onto one of the exposed surfaces of the sliced fiber to cover at least a portion of the fiber core. Various deposition methods well known in the art, such as, for example, spray coating or chemical vapor deposition, may be used for the filter deposition. The fiber portions are then reconnected and secured together to have the filter sandwiched between said portions.

During operation, sensors 104 and 106 are interrogated by a beam of light having at least two wavelength components labeled λ1 and λ2 in FIG. 1, where component λ1 corresponds to sensor 104 and component λ2 corresponds to sensor 106. Component λ1 launched along fiber 102 toward the sensors takes the following optical path: it (i) reaches filter 108, (ii) is reflected by the filter toward sensor 104, (iii) reaches the sensor, (iv) is reflected back by the sensor (thereby interrogating the sensor), (v) again reaches the filter, and (vi) is reflected by the filter in the direction opposite to the initial propagation direction. Similarly, component λ2 reaches filter 108, passes through the filter toward sensor 106, reaches the sensor, is reflected back by the sensor in the direction opposite to the initial propagation direction (thereby interrogating the sensor), and again reaches and passes through the filter.

As indicated by the above description, one difference between fiber-optic gauge 100 (FIG. 1) and a typical prior-art gauge is that gauge 100 has a side-mounted sensor (i.e., sensor 104) that is mounted on fiber 102 and is optically coupled to the fiber core using filter 108, while, in prior-art gauges, sensors are terminus-mounted. Another difference is that different sensors in gauge 100 are designed for interrogation with light of different wavelengths. As a result of these differences, a single optical fiber can be used to support a plurality of sensors. This is advantageously different from prior-art gauges, where a plurality of optical fibers is used to support a plurality of sensors.

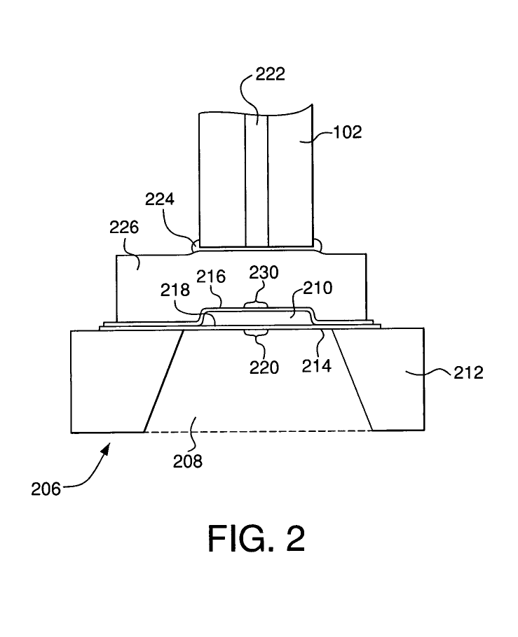

FIG. 2 shows a cross-sectional view of a pressure sensor 206 that can be used as sensor 106 in gauge 100 according to one embodiment of the present invention. More specifically, sensor 206 is similar to a sensor disclosed in commonly owned U.S. Pat. No. 5,831,262, the teachings of which are incorporated herein by reference. Briefly, sensor 206 includes a sealed chamber 210 defined by (i) a layer 214 having a movable portion 218 and (ii) a fixed layer 216, both layers supported on a substrate layer 212. Fixed layer 216 is attached to an optically transparent (e.g., glass) layer 226 to which the terminus of fiber 102 is glued using a transparent cement layer 224. Layers 224 and 226 are preferably index-matched to core 222 of fiber 102. Movable portion 218 of layer 214 is exposed to external pressure through an opening 208 in substrate layer 212 and can move in response to pressure changes. For example, when the pressure in opening 208 exceeds the pressure in chamber 210, portion 218 moves toward fixed layer 216. Similarly, when the pressure in opening 208 is lower than the pressure in chamber 210, portion 218 moves away from fixed layer 216. Portion 218 is in equilibrium when the total force exerted on the portion by the pressure in chamber 210, the pressure in opening 208, and elastic deformation of layer 214 is equal to zero.

Central portions 220 and 230 of layers 214 and 216, respectively, are optically coupled to fiber core 222 and form a Fabry-Perot interferometer (FPI) of sensor 206, which FPI has variable cavity length due to the mobility of portion 220. In contrast to prior-art sensors that are designed for interrogation with white light, sensor 206 is designed to be preferably interrogated with monochromatic light, for example, at wavelength 2. The cavity length and thereby the pressure in opening 208 can be derived based on the reflectivity of the FPI. More details on the optical response of the FPI in sensor 206, pressure determination based on said response, and methods of manufacture can be found in the above-cited '262 patent.

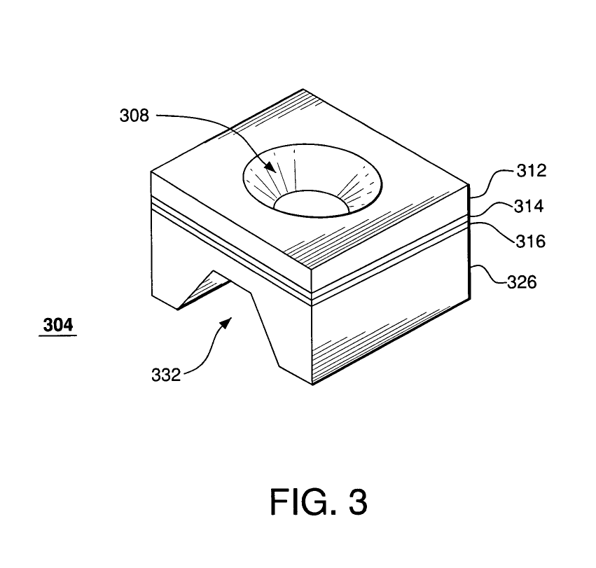

FIG. 3 shows a perspective three-dimensional view of a pressure sensor 304 that can be used as sensor 104 in gauge 100 according to one embodiment of the present invention. Sensor 304 is similar to sensor 206 (FIG. 2) with corresponding structural elements of the two sensors labeled in FIGS. 2 and 3 using numerals having the same last two digits. However, one difference between sensors 304 and 206 is in the shape of their respective glass layers 326 and 226. More specifically, glass layer 326 of sensor 304 has an opening 332 into which fiber 102 may be inserted sideways and glued using a transparent cement layer similar to cement layer 224 of FIG. 2. Another difference between sensors 304 and 206 is that sensor 304 is designed to be interrogated using a different wavelength than sensor 206, for example, wavelength λ1. In one implementation, the spacing between λ1 and λ2 is on the order of 100 nm.

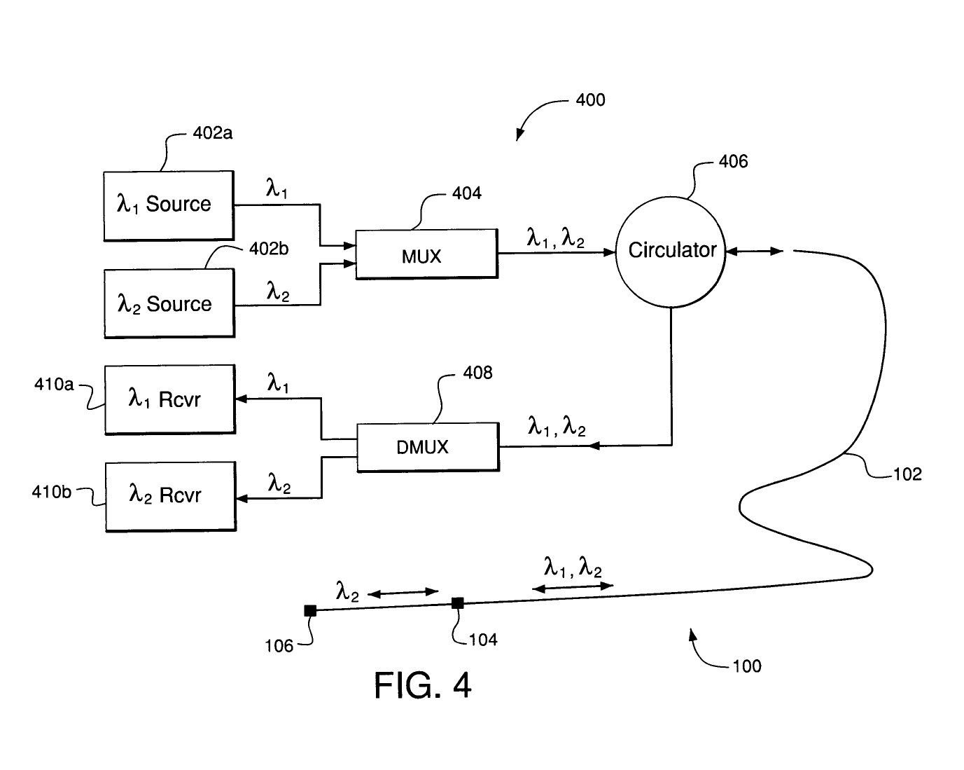

FIG. 4 shows a block diagram of a gauge interrogation device 400 according to one embodiment of the present invention, where device 400 is configured to interrogate gauge 100 of FIG. 1. Device 400 includes two light sources (e.g., laser diodes) 402a-b configured to generate monochromatic light at wavelengths λ1 and λ2 respectively. Light generated by sources 402a-b is (i) multiplexed using an optical multiplexer (MUX) 404 and (ii) coupled into fiber 102 of gauge 100 via an optical circulator 406. After interrogating sensors 104 and 106 of gauge 100 as described above and exiting fiber 102, the reflected light is directed by circulator 406 to an optical de-multiplexer (DMUX) 408, where it is decomposed into two beams having light λ1 and λ2 respectively. Each beam is then applied to a corresponding receiver 410a or 410b, e.g., to measure the beam intensity. The response of each receiver is processed, e.g., as described in the above-cited '262 patent, to obtain a pressure value for the corresponding sensor of gauge 100. In a different embodiment, a gauge interrogation device similar to device 400 may be constructed to have more than two light sources and receivers, where each light source/receiver pair corresponds to a different sensor operating at a different wavelength in a fiber-optic gauge analogous to gauge 100.

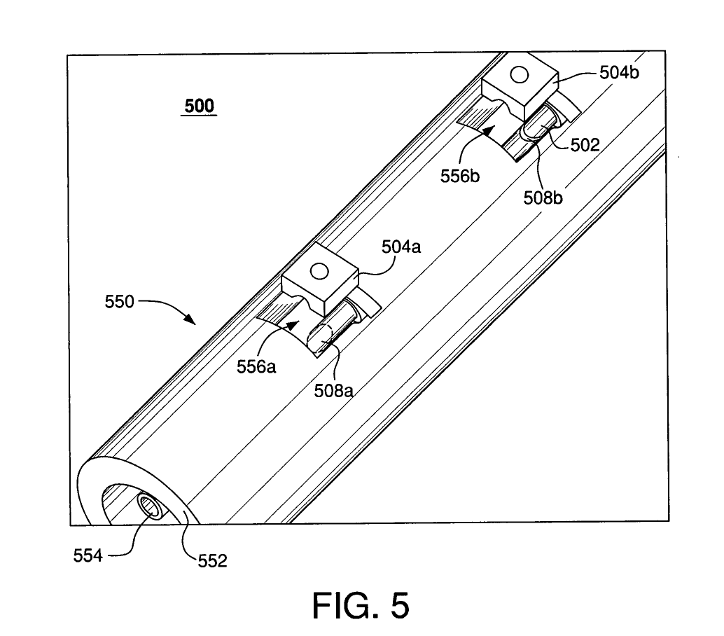

FIG. 5 shows a partial cut-away perspective view of a portion of a medical device 500 according to one embodiment of the present invention. Device 500 includes an intra-aortic balloon (LAB) catheter 550 that is similar to an LAB co-lumen catheter available from Datascope Corp. of Montvale, N.J. Catheter 550 has an external tube 552 enclosing an internal tube 554, which is attached to the inner wall of the external tube. External tube 552 has two openings 556a-b, each sized and shaped to accommodate a corresponding pressure sensor 504a/504b, while internal tube 554 accommodates an optical fiber 502 having thin-film filters 508a-b. Fiber 502, each of filters 508, and each of sensors 504 are similar to fiber 102, filter 108, and sensor 104, respectively, of fiber-optic gauge 100 (FIG. 1). Each sensor 504 is inserted into the corresponding opening 556 and attached to fiber 502 such that the corresponding filter 508 is aligned with the sensor. After the sensor insertion, openings 556a-b are sealed such that sensors 504a-b remain exposed on the exterior of external tube 552. When device 500 is inserted into a blood vessel (e.g., an aorta), sensors 504a-b can be used to monitor blood pressure at their respective locations. An additional sensor (not shown) similar to sensor 106 of FIG. 1 may be attached at the terminus of fiber 502 to monitor fluid pressure inside catheter 550. Advantageously, during a medical procedure, device 500 may be positioned in a blood vessel such that a damaged area of the vessel, e.g., a blood clot, is located between sensors 504a and 504b thereby sampling blood pressure around the damaged area.

While this invention has been described with reference to illustrative embodiments, this description is not intended to be construed in a limiting sense. Although the invention was described in reference to fiber-optic gauges having pressure sensors, other (strain, stress, temperature, etc.) optically interrogated sensors may similarly be used. Furthermore, a gauge of the invention may include sensors of two or more different types, for example, a pressure sensor and a temperature sensor. A fiber-optic gauge of the invention may include one or more of side-mounted sensors (e.g., sensors 104) and none or one of terminus-mounted sensors (e.g., sensor 106). Different sensors may be designed for light of different wavelengths including ultra-violet, visible, and infrared light. Each individual sensor may be designed for interrogation with more than one wavelength, e.g., two wavelengths or a wavelength band, to provide data redundancy. Optical properties of each thin-film filter can be tailored to reflect light corresponding to the sensor associated with the filter and to transmit light corresponding to all other sensors. In systems without a terminus-mounted sensor, a metal (e.g., gold) film can be used in place of the filter having the far-most downstream location (e.g., filter 508b in device 500). Different types of fiber, e.g., bend-insensitive, multimode, etc., may be used in the gauges of the invention. Various modifications of the described embodiments, as well as other embodiments of the invention, which are apparent to persons skilled in the art to which the invention pertains are deemed to lie within the principle and scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A sensing system adapted to measure one or more values corresponding to one or more physical parameters, the system comprising:
a first sensor mounted onto a side of an optical fiber and optically coupled to said fiber, wherein, when interrogated with light coupled into the fiber, the first sensor generates an optical response corresponding to a first value of a first physical parameter to provide a measure of the first value.

2. The system of claim 1, further comprising:
a first optical filter inserted into the fiber, wherein the first filter is adapted to direct light corresponding to the first sensor between the fiber and the first sensor.

3. The system of claim 2, wherein the filter is aligned with the first sensor and oriented at about 45 degrees with respect to the longitudinal axis of the fiber.

4. The system of claim 2, further comprising a second sensor optically coupled to the fiber, wherein the first filter is designed to be substantially transparent to light corresponding to the second sensor.

5. The system of claim 4, wherein the second sensor is mounted at a terminus of the fiber.

6. The system of claim 4, further comprising:
a second optical filter inserted into the fiber, wherein:
the second sensor is mounted onto the side of the fiber at a location downstream from the location of the first sensor; and
the second filter is adapted to direct light corresponding to the second sensor between the fiber and the second sensor.

7. The system of claim 4, wherein, when interrogated with the light coupled into the fiber, the second sensor generates an optical response corresponding to a second value of the first physical parameter to provide a measure of the second value.

8. The system of claim 4, wherein, when interrogated with the light coupled into the fiber, the second sensor generates an optical response corresponding to a value of the second physical parameter different from the first physical parameter to provide a measure of said value.

9. The system of claim 2, wherein the light corresponding to the first sensor is substantially monochromatic light.

10. The system of claim 1, further comprising:
an interrogation device optically coupled to the fiber and adapted to (i) generate the interrogating light and (ii) detect the optical response.

11. The system of claim 1, further comprising:
a catheter having an external tube and an internal tube enclosed by the external tube, wherein:
the internal tube accommodates the fiber;
the first sensor protrudes through the internal and external tubes;
the first physical parameter is pressure; and
the system is adapted to measure blood pressure in a blood vessel.

12. The system of claim 1, wherein the first sensor comprises:
a first layer supported on a substrate, the first layer having a portion adapted to move with respect to the substrate under influence of the first physical parameter;
a second layer supported on and fixed with respect to the substrate, wherein the first and second layers form a sealed chamber physically connected and optically coupled to the fiber, wherein:
when the portion is moved, the reflectivity of the chamber changes.

13. The system of claim 1, wherein the first sensor is one of a plurality of sensors, in which each sensor is optically coupled to the fiber.

14. The system of claim 13, further comprising:
an interrogation device including, for each sensor:
a light source and a receiver, wherein:
each light source is optically coupled to an optical multiplexer adapted to combine light from different light sources and apply the combined light to the fiber; and
each receiver is optically coupled to an optical de-multiplexer adapted to receive from the fiber light reflected from the sensors, decompose the received light into a plurality of components, each component corresponding to a different sensor, and apply each component to the corresponding receiver.

15. The system of claim 1, further comprising a second sensor optically coupled to the fiber, wherein, when interrogated with the light coupled into the fiber, the second sensor generates an optical response corresponding to a second value of the first physical parameter to provide a measure of the second value.

16. The system of claim 1, further comprising a second sensor optically coupled to the fiber, wherein, when interrogated with the light coupled into the fiber, the second sensor generates an optical response corresponding to a value of the second physical parameter different from the first physical parameter to provide a measure of said value.

17. An optical arrangement, comprising:
an optical filter inserted into an optical fiber; and
an optical device mounted onto a side of the fiber and optically coupled to the fiber, wherein the filter is configured to direct light corresponding to the optical device between the fiber and the optical device.

18. The arrangement of claim 17, wherein the filter is aligned with the optical device and oriented at about 45 degrees with respect to the longitudinal axis of the fiber.

19. The arrangement of claim 17, wherein the optical device is a sensor adapted to measure a value corresponding to a physical parameter, the sensor comprising:
a first layer supported on a substrate, the first layer having a portion adapted to move with respect to the substrate under influence of the first physical parameter;
a second layer supported on and fixed with respect to the substrate, wherein the first and second layers form a sealed chamber physically connected and optically coupled to the fiber, wherein:
when the portion is moved, the reflectivity of the chamber changes.

20. A method of coupling an optical device to an optical fiber, comprising:
inserting an optical filter into the fiber; and
mounting the optical device onto a side of the fiber, wherein:
the device is optically coupled to the fiber; and
the filter is configured to direct light corresponding to the device between the fiber and the device.
